(19) United States
(12) Patent Application Publication
(10) Pub. No.: US 2017/0086186 A1
(43) Pub. Date: Mar. 23, 2017

(54) METHOD AND APPARATUS FOR PROVIDING NETWORK ACCESS TO A USER EQUIPMENT REQUESTING VOICE SERVICE

(71) Applicant: HUAWEI TECHNOLOGIES CO., LTD., Shenzhen (CN)

(72) Inventor: Yanglai SHUAI, Shanghai (CN)

(21) Appl. No.: 15/352,416

(22) Filed: Nov. 15, 2016

Related U.S. Application Data
(63) Continuation of application No. PCT/CN2014/077648, filed on May 16, 2014.

(51) Int. Cl. H04W 72/04; H04W 76/04

(52) U.S. Cl. CPC H04W 72/048; H04W 76/046; H04W 88/02

(57) ABSTRACT

Embodiments of the present invention provide a method and apparatus for providing network access to user equipment (UE) requesting a voice service, where the method includes: receiving, by a base station, an RRC connection request sent by first UE, where a setup reason in the RRC connection request is a voice call; sending, by the base station, an RRC connection setup message to the first UE.

### CROSS-REFERENCE TO RELATED APPLICATIONS

This application is a continuation of International Patent Application No. PCT/CN2014/077648, filed on May 16, 2014, which is hereby incorporated by reference in its entirety.

### TECHNICAL FIELD

Embodiments of the present invention relate to the field of wireless communications technologies, and in particular, to a method and apparatus for providing network access to user equipment requesting a voice service.

### BACKGROUND

In the field of wireless communications, services may be classified into two categories: a voice service and a data service. In a conventional wireless communications network, the data service is performed by using a packet switched (PS) domain network, and the voice service is performed by using a circuit switched (CS) domain network.

With development of wireless communications technologies, the wireless communications network has gradually evolved to a Long Term Evolution (LTE) network, and the LTE network is a network based on a PS domain, and a voice service in the LTE network is transmitted in a manner based on the Voice over Internet Protocol (VOIP). For a PS domain network that does not support the VoIP, a fallback from the PS domain network to a CS domain network, that is, a circuit switched fallback (CSFB), is required, and a voice service is performed by using the CS domain network.

User equipment in a wireless network needs to access the network by using a base station; however, the number of accessing user equipments supported by the base station is limited. When a number specification of the accessing user equipments supported by the base station is reached, the base station cannot implement access of user equipment that initiates a voice call.

### SUMMARY

Embodiments of the present invention provide a method and apparatus for providing network access to a user equipment requesting a voice service, so that user equipment that initiates a voice call can access a network when a base station is congested.

A first aspect provides a base station, including:

a first receiving unit, configured to receive an radio resource control (RRC) connection request sent by first UE, where a setup reason in the RRC connection request is a voice call;

a first sending unit, configured to send an RRC connection setup message to the first UE when the base station is in a congested state; where

the first receiving unit is further configured to receive an RRC connection setup completion message sent by the first UE, where the RRC connection setup completion message carries a service request;

a second sending unit, further configured to send the service request to a mobility management entity (MME); and

a second receiving unit, further configured to receive an initial context setup request sent by the MME; where

the first sending unit is further configured to send an RRC connection reconfiguration message to the first UE; and

the first receiving unit is further configured to receive an RRC connection reconfiguration completion message sent by the first UE, so that the first UE completes voice service access.

In a first possible implementation manner of the first aspect, the base station further includes:

a processing unit, configured to: after the first receiving unit receives the RRC connection request sent by the first UE, determine second UE that can release a resource; and release the resource of the second UE.

With reference to the first possible implementation manner of the first aspect, in a second possible implementation manner, the processing unit is specifically configured to determine the second UE that can release the resource, and a setup reason of the second UE is a non-voice call.

In a third possible implementation manner of the first aspect, the base station further includes:

a processing unit, configured to: after the second receiving unit receives the initial context setup request sent by the MME, determine second UE that can release a resource; and release the resource of the second UE.

With reference to the third possible implementation manner of the first aspect, in a fourth possible implementation manner, the processing unit is specifically configured to determine, according to a user priority, a service priority, or a setup reason, the second UE that can release the resource.

With reference to the third possible implementation manner of the first aspect, in a fifth possible implementation manner, the processing unit is specifically configured to determine, according to a user priority and a setup reason, or a service priority and a setup reason, the second UE that can release the resource.

With reference to the fourth or the fifth possible implementation manner of the first aspect, in a sixth possible implementation manner, the user priority or the service priority includes:

an allocation and retention priority (ARP).

With reference to any one of the first aspect to the sixth possible implementation manner of the first aspect, in a seventh possible implementation manner, the voice call includes: the VoIP or a CSFB.

With reference to any one of the first aspect to the seventh possible implementation manner of the first aspect, in an eighth possible implementation manner, the processing unit is further configured to: when a number of UEs that have accessed reaches a maximum capability value of the base station, determine that the base station is in the congested state; or when a number of UEs that have accessed reaches an access license quantity value of the base station, determine that the base station is in the congested state.

A second aspect provides user equipment, including:

a sending unit, configured to send an RRC connection request to a base station, where a setup reason in the RRC connection request is a voice call; and

a receiving unit, configured to receive an RRC connection setup message sent by the base station, where the RRC connection setup message is sent by the base station to the UE based on the setup reason of a voice call when the base station is in a congested state; where

the sending unit is further configured to send an RRC connection setup completion message to the base station, where the RRC connection setup completion message carries a service request, so that the base station sends the service request to an MME;

the receiving unit is further configured to receive an RRC connection reconfiguration message sent by the base station, and the RRC connection reconfiguration message is sent to the UE after the base station receives an initial context setup request sent by the MME; and

the sending unit is further configured to send an RRC connection reconfiguration completion message to the base station, so as to complete voice service access.

In a first possible implementation manner of the second aspect, the voice call includes: the VoIP or a CSFB.

A third aspect provides a method for providing network access to user equipment requesting a voice service, including:

receiving, by a base station, an RRC connection request sent by first UE, where a setup reason in the RRC connection request is a voice call;

sending, by the base station, an RRC connection setup message to the first UE when the base station is in a congested state;

receiving, by the base station, an RRC connection setup completion message sent by the first UE, where the RRC connection setup completion message carries a service request;

sending, by the base station, the service request to an MME;

receiving, by the base station, an initial context setup request sent by the MME;

sending, by the base station, an RRC connection reconfiguration message to the first UE; and

receiving, by the base station, an RRC connection reconfiguration completion message sent by the first UE, so that the first UE completes voice service access.

In a first possible implementation manner of the third aspect, after the receiving, by a base station, an RRC connection request sent by first UE, the method further includes:

determining, by the base station, second UE that can release a resource; and

the method further includes:

releasing, by the base station, the resource of the second UE.

With reference to the first possible implementation manner of the third aspect, in a second possible implementation manner, the determining, by the base station, second UE that can release a resource includes:

determining, by the base station, the second UE that can release the resource, where a setup reason of the second UE is a non-voice call.

In a third possible implementation manner of the third aspect, after the receiving, by the base station, an initial context setup request sent by the MME, the method further includes:

determining, by the base station, second UE that can release a resource; and

the method further includes:

releasing, by the base station, the resource of the second UE.

With reference to the third possible implementation manner of the third aspect, in a fourth possible implementation manner, the determining second UE that can release a resource includes:

determining, by the base station according to a user priority, a service priority, or a setup reason, the second UE that can release the resource.

With reference to the third possible implementation manner of the third aspect, in a fifth possible implementation manner, the determining, by the base station, second UE that can release a resource includes:

determining, by the base station according to a user priority and a setup reason, or a service priority and a setup reason, the second UE that can release the resource.

With reference to the fourth or the fifth possible implementation manner of the third aspect, in a sixth possible implementation manner, the user priority or the service priority includes:

an ARP.

With reference to any one of the third aspect to the sixth possible implementation manner of the third aspect, in a seventh possible implementation manner, the voice call includes: the VoIP or a CSFB.

With reference to any one of the third aspect to the seventh possible implementation manner of the third aspect, in an eighth possible implementation manner, that the base station is in the congested state includes:

when a number of UEs that have accessed reaches a maximum capability value of the base station, determining, by the base station, that the base station is in the congested state; or

when a number of UEs that have accessed reaches an access license quantity value of the base station, determining, by the base station, that the base station is in the congested state.

A fourth aspect provides a method for providing network access to a user equipment requesting a voice service, including:

sending, by first UE, an RRC connection request to a base station, where a setup reason in the RRC connection request is a voice call;

receiving, by the first UE, an RRC connection setup message sent by the base station, where the RRC connection setup message is sent by the base station to the first UE based on the setup reason of a voice call when the base station is in a congested state;

sending, by the first UE, an RRC connection setup completion message to the base station, where the RRC connection setup completion message carries a service request, so that the base station sends the service request to an MME;

receiving, by the first UE, an RRC connection reconfiguration message sent by the base station, where the RRC connection reconfiguration message is sent to the first UE after the base station receives an initial context setup request sent by the MME; and

sending, by the first UE, an RRC connection reconfiguration completion message to the base station, so as to complete voice service access.

In a first possible implementation manner of the fourth aspect, the voice call includes: the VoIP or a CSFB.

A fifth aspect provides a base station, including:

a first receiving unit, configured to receive an RRC connection request sent by first UE;

a first sending unit, configured to send an RRC connection setup message to the first UE when the base station is in a congested state; where

the first receiving unit is further configured to receive an RRC connection setup completion message sent by the first UE, the RRC connection setup completion message carries a service request, and the service request carries indication information of a voice call;

a second sending unit, further configured to send the service request to an MME; and

a second receiving unit, further configured to receive an initial context setup request sent by the MME; where

the first sending unit is further configured to send an RRC connection reconfiguration message to the first UE, so that the first UE completes voice service access.

In a first possible implementation manner of the fifth aspect, the base station further includes:

a processing unit, configured to: after the second receiving unit receives the initial context setup request sent by the MME, determine second UE that can release a resource; and release the resource of the second UE.

With reference to the first possible implementation manner of the fifth aspect, in a second possible implementation manner, the processing unit is specifically configured to determine, according to a user priority or a service priority, the second UE that can release the resource.

With reference to the second possible implementation manner of the fifth aspect, in a third possible implementation manner, the user priority or the service priority includes:

an ARP.

With reference to any one of the fifth aspect to the third possible implementation manner of the fifth aspect, in a fourth possible implementation manner, the indication information of a voice call includes: VoIP indication information or CSFB indication information.

With reference to any one of the fifth aspect to the fourth possible implementation manner of the fifth aspect, in a fifth possible implementation manner, the processing unit is further configured to: when a number of UEs that have accessed reaches a maximum capability value of the base station, determine that the base station is in the congested state; or when a number of UEs that have accessed reaches an access license quantity value of the base station, determine that the base station is in the congested state.

A sixth aspect provides user equipment, including:

a sending unit, configured to send an RRC connection request to a base station; and

a receiving unit, configured to receive an RRC connection setup message sent by the base station, where the RRC connection setup message is sent by the base station to the UE when the base station is in a congested state; where

the sending unit is further configured to send an RRC connection setup completion message to the base station, the RRC connection setup completion message carries a service request, and the service request carries indication information of a voice call, so that the base station sends the service request to an MME, and after the base station receives an initial context setup request sent by the MME, the base station sends an RRC connection reconfiguration message to the UE;

the receiving unit is further configured to receive the RRC connection reconfiguration message sent by the base station, and the RRC connection reconfiguration message is sent to the UE after the base station receives the initial context setup request sent by the MME; and

the sending unit is further configured to send an RRC connection reconfiguration completion message to the base station, so as to complete voice service access.

In a first possible implementation manner of the sixth aspect, the indication information of a voice call includes: VoIP indication information or CSFB indication information.

A seventh aspect provides a mobility management entity, including:

a receiving unit, configured to receive a service request sent by a base station, where the service request carries indication information of a voice call, the service request is sent to the MME after the base station receives an RRC connection request sent by first UE and when the base station is in a congested state, and the RRC connection request carries the service request; and

a sending unit, configured to send an initial context setup request to the base station, so that the base station sends an RRC connection reconfiguration message to the first UE and the first UE completes voice service access.

In a first possible implementation manner of the seventh aspect, the mobility management entity further includes:

a processing unit, configured to configure the initial context setup request for the first UE according to the indication information of a voice call, where a user priority or a service priority in the initial context setup request is a high priority.

With reference to the first possible implementation manner of the seventh aspect, in a second possible implementation manner, the user priority or the service priority includes:

an ARP.

With reference to any one of the seventh aspect to the second possible implementation manner of the seventh aspect, in a third possible implementation manner, the voice call includes: the VoIP or a CSFB.

An eighth aspect provides a method for providing network access to a user equipment requesting a voice service, including:

receiving, by a base station, an RRC connection request sent by first UE;

sending, by the base station, an RRC connection setup message to the first UE when the base station is in a congested state;

receiving, by the base station, an RRC connection setup completion message sent by the first UE, where the RRC connection setup completion message carries a service request, and the service request carries indication information of a voice call;

sending, by the base station, the service request to an MME;

receiving, by the base station, an initial context setup request sent by the MME; and

sending, by the base station, an RRC connection reconfiguration message to the first UE, so that the first UE completes voice service access.

In a first possible implementation manner of the eighth aspect, after the receiving, by the base station, an initial context setup request sent by the MME, the method further includes:

determining, by the base station, second UE that can release a resource; and

the method further includes:

releasing, by the base station, the resource of the second UE.

With reference to the first possible implementation manner of the eighth aspect, in a second possible implementation manner, the determining, by the base station, second UE that can release a resource includes:

determining, by the base station according to a user priority or a service priority, the second UE that can release the resource.

With reference to the second possible implementation manner of the eighth aspect, in a third possible implementation manner, the user priority or the service priority includes:

an ARP.

With reference to any one of the eighth aspect to the third possible implementation manner of the eighth aspect, in a fourth possible implementation manner, the voice call includes: the VoIP or a CSFB.

With reference to any one of the eighth aspect to the fourth possible implementation manner of the eighth aspect, in a fifth possible implementation manner, that the base station is in the congested state includes:

when a number of UEs that have accessed reaches a maximum capability value of the base station, determining, by the base station, that the base station is in the congested state; or

when a number of UEs that have accessed reaches an access license quantity value of the base station, determining, by the base station, that the base station is in the congested state.

A ninth aspect provides a method for providing network access to user equipment requesting a voice service, including:

sending, by first UE, an RRC connection request to a base station;

receiving, by the first UE, an RRC connection setup message sent by the base station, where the RRC connection setup message is sent by the base station to the first UE when the base station is in a congested state;

sending, by the first UE, an RRC connection setup completion message to the base station, where the RRC connection setup completion message carries a service request, and the service request carries indication information of a voice call, so that the base station sends the service request to an MME, and after the base station receives an initial context setup request sent by the MME, the base station sends an RRC connection reconfiguration message to the first UE;

receiving, by the first UE, the RRC connection reconfiguration message sent by the base station, where the RRC connection reconfiguration message is sent to the first UE after the base station receives the initial context setup request sent by the MME; and

sending, by the first UE, an RRC connection reconfiguration completion message to the base station, so as to complete voice service access.

In a first possible implementation manner of the ninth aspect, the voice call includes: the VoIP or a CSFB.

A tenth aspect provides a method for providing network access to a user equipment requesting a voice service, including:

receiving, by an MME, a service request sent by a base station, where the service request carries indication information of a voice call, the service request is sent to the MME after the base station receives an RRC connection request sent by first UE and when the base station is in a congested state, and the RRC connection request carries the service request; and

sending, by the MME, an initial context setup request to the base station, so that the base station sends an RRC connection reconfiguration message to the first UE and the first UE completes voice service access.

In a first possible implementation manner of the tenth aspect, before the sending, by the MME, an initial context setup request to the base station, the method further includes:

configuring, by the MME, the initial context setup request for the first UE according to the indication information of a voice call, where a user priority or a service priority in the initial context setup request is a high priority.

With reference to the first possible implementation manner of the tenth aspect, in a second possible implementation manner, the user priority or the service priority includes:

an ARP.

With reference to any one of the tenth aspect to the second possible implementation manner of the tenth aspect, in a third possible implementation manner, the voice call includes: the VoIP or a CSFB.

According to the method and apparatus for providing network access to a user equipment requesting a voice service that are provided in the embodiments of the present invention, a setup reason of a voice call is added to an RRC connection request message that is sent to a base station by user equipment, so that the base station allows access of the user equipment when the base station is in a congested state.

### BRIEF DESCRIPTION OF DRAWINGS

To describe the technical solutions in the embodiments of the present invention more clearly, the following briefly describes the accompanying drawings required for describing the embodiments. Apparently, the accompanying drawings in the following description show some embodiments of the present invention, and persons of ordinary skill in the art may still derive other drawings from these accompanying drawings without creative efforts.

FIG. 1 is a schematic diagram of an architecture of a wireless communications network;

FIG. 2 is a flowchart of a method for providing network access to UE requesting a voice service according to an embodiment of the present invention;

FIG. 3 is a flowchart of a method for providing network access to UE requesting a voice service according to an embodiment of the present invention;

FIG. 4 is a flowchart of a method for providing network access to UE requesting a voice service according to an embodiment of the present invention;

FIG. 5 is a flowchart of a method for providing network access to UE requesting a voice service according to an embodiment of the present invention;

FIG. 6 is a flowchart of a method for providing network access to UE requesting a voice service according to an embodiment of the present invention;

FIG. 7 is a schematic structural diagram of a base station according to an embodiment of the present invention;

FIG. 8 is a schematic structural diagram of a base station according to an embodiment of the present invention;

FIG. 9 is a schematic structural diagram of UE according to an embodiment of the present invention;

FIG. 10 is a schematic structural diagram of an MME according to an embodiment of the present invention; and

FIG. 11 is a schematic structural diagram of an MME according to an embodiment of the present invention.

### DESCRIPTION OF EMBODIMENTS

To make the objectives, technical solutions, and advantages of the embodiments of the present invention clearer, the following clearly describes the technical solutions in the embodiments of the present invention with reference to the accompanying drawings in the embodiments of the present invention. Apparently, the described embodiments are a part rather than all of the embodiments of the present invention. All other embodiments obtained by persons of ordinary skill in the art based on the embodiments of the present invention without creative efforts shall fall within the protection scope of the present invention.

When user equipment (UE) initiates a data service, congestion occurring in a network may cause a rate of the data service to decrease or the data service to be interrupted. Compared with the data service, a voice service has a higher requirement for quality of the network, and when the UE initiates a voice service, the congestion occurring in the network may cause quality of a call of the voice service to decrease or the voice call to fail. A failure or reduced quality of the call of the voice service (for example, during the call, noise occurs or the call is discontinuous, or the like) greatly affects user experience. Therefore, when the network is congested, the voice service need to be firstly assured.

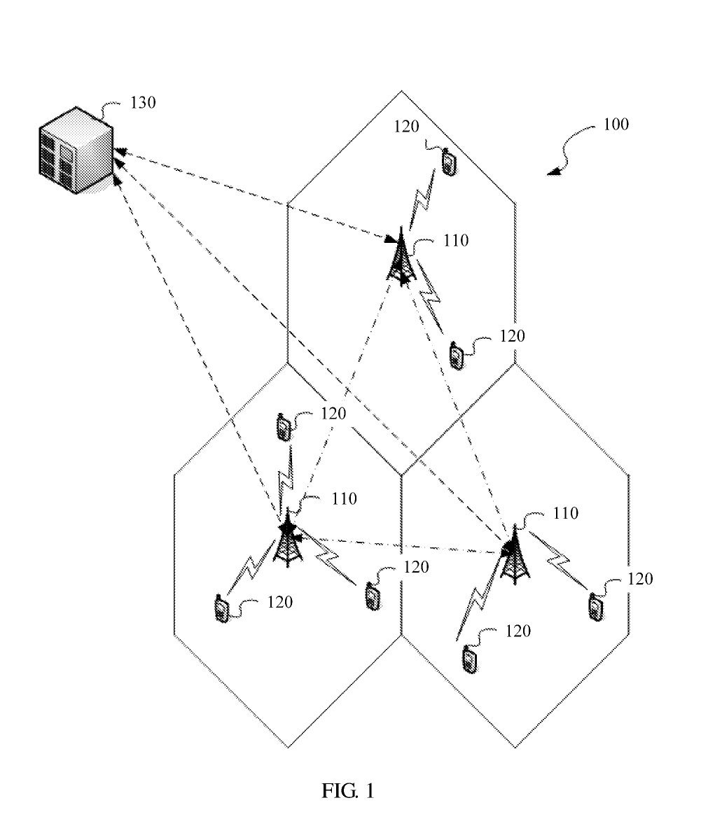

FIG. 1 is a schematic diagram of an architecture of a wireless communications network. A wireless communications network 100 is shown in FIG. 1. The wireless communications network 100 includes several base stations 110 and another network entity, and is used to support communication of several user equipments 120. For ease of description, the following uses an LTE network as an example for description.

The base station 110 may be an evolved NodeB (eNB) in LTE. One base station 110 may support/manage one or more cells. When user equipment (UE) 120 needs to communicate with a network, the UE 120 selects a cell to initiate access.

The UE 120 may also be referred to as a mobile terminal, a mobile station, or the like, and may communicate with one or more core networks by using a radio access network (RAN).

A core network device 130 is connected to one or more base stations 110, and the core network device 130 includes a mobility management entity (MME).

Because a hardware capability is limited or a software configuration is limited, a number of UEs 120 that can access the base station 110 is limited. In principle, when a number of UEs 120 that have accessed the base station 110 reaches a maximum number that the base station 110 supports, and when new UE 120 intends to access the network by using the base station 110, the base station 110 rejects access of the UE 120 to the network.

When accessing the network, the UE 120 sends a Radio Resource Control (RRC) connection request to the base station 110 to start the RRC connection setup. The RRC connection request is used to request a radio resource in the network. A radio resource is allocated to the UE 120 only when the base station 110 allows access of the UE 120. However, when the base station 110 is in a congested state, and the UE 120 sends an RRC connection request to the base station 110, the base station 110 already has no extra radio resource available for allocation, and therefore the UE 120 cannot perform service connection, which is unacceptable for a voice service.

In the prior art, when UE sends an RRC connection request to a base station, the RRC connection request carries a setup reason, where the setup reason may indicate or be, for example: emergency (Emergency), high priority access (High Priority Access), mobile terminating access (mt-Access), mobile originating access (mo-Access), mobile originating signaling (mo-Signaling), mobile originating data (mo-Data), or delay tolerant access (Delay Tolerant Access), or the like. However, whether it is a voice service is not distinguished by the foregoing setup reason, and the base station cannot determine, by using the foregoing cause value, whether the UE that sends the RRC connection request needs to perform a voice service.

That the base station is in the congested state may include: the number of UEs that have accessed reaches a maximum number of accessing users that is supported by the base station; or the number of UEs that have accessed reaches a number of access licenses (License) bought for the base station.

To resolve the foregoing problem, embodiments of the present invention provide a method and apparatus for providing network access to UE requesting a voice service. By adding a setup reason of a voice call to an RRC connection request that is sent to a base station by UE, when in a congested state, the base station still allows UE that performs a voice service to access a network, thereby improving user experience of the voice service.

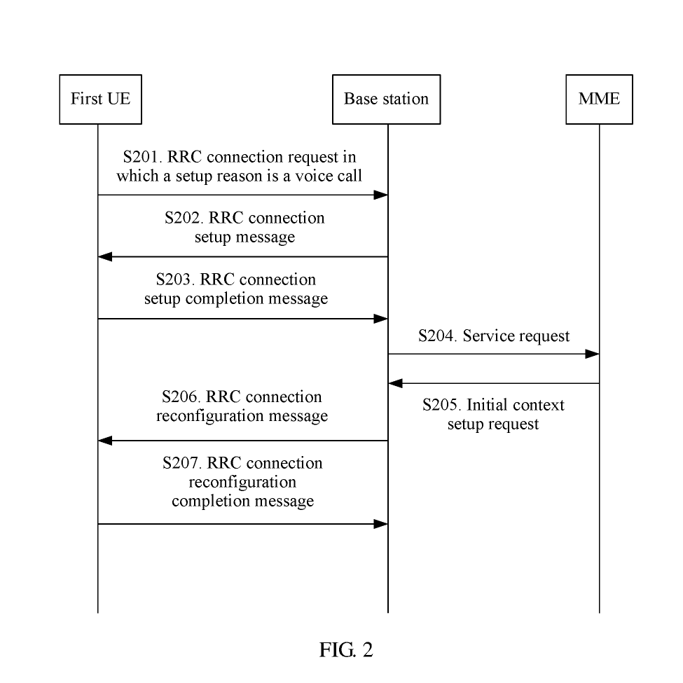

FIG. 2 is a flowchart of a method for providing network access to UE requesting a voice service according to an embodiment of the present invention. As shown in FIG. 2, the method in this embodiment includes:

S201. First UE sends an RRC connection request to a base station, where a setup reason in the RRC connection request is or indicates a voice call.

To indicate a service of a voice call, the setup reason in the RRC connection request includes a setup reason being the voice call, and the voice call includes, but is not limited to, the VoIP or a CSFB.

When initiating a voice service, the first UE in an idle state sends an RRC connection request to the base station, where a setup reason in the RRC connection request is a voice call.

S202. The base station sends an RRC connection setup message to the first UE when the base station is in a congested state.

When the base station is in the congested state, because the setup reason of the first UE that sends the RRC connection request to the base station is the voice call, to ensure that the UE of the voice call can access a network, after the base station receives the RRC connection request sent by the first UE, the base station sends the RRC connection setup message to the first UE, based on the setup reason being a voice call.

S203. The first UE sends an RRC connection setup completion message to the base station, where the RRC connection setup completion message carries a service request.

After receiving the RRC connection setup message, the first UE sends the RRC connection setup completion message to the base station, where the RRC connection setup completion message carries the service request, and the service request is a non-access stratum (NAS) message.

S204. The base station sends the service request to an MME.

The base station obtains the service request after receiving the RRC connection setup completion message sent by the UE. Because the service request is the NAS message, the base station sends the service request to the MME. Optionally, the base station sends an initial UE message carrying the service request to the MME.

S205. The MME sends an initial context setup request to the base station.

After receiving the service request, the MME allocates related access information to the first UE, configures initial context information for the first UE, and then sends the initial context setup request to the base station.

S206. The base station sends an RRC connection reconfiguration message to the first UE.

After receiving the initial context setup request sent by the MME, the base station sends the RRC connection reconfiguration message to the first UE.

S207. The first UE sends an RRC connection reconfiguration completion message to the base station.

The first UE receives the RRC connection reconfiguration message sent by the base station, performs configuration, and sends the RRC connection reconfiguration completion message to the base station after the configuration is complete, so that after receiving the RRC connection reconfiguration completion message sent by the first UE, the base station further exchanges information with the MME, thereby completing voice service access of the first UE.

Generally, a base station may operate when overloaded within a range. According to this embodiment, by adding a setup reason of a voice call to an RRC connection request that is sent to the base station by UE, when in a congested state, the base station still allows UE that performs a voice service to access a network, thereby improving user experience of the UE providing a voice service.

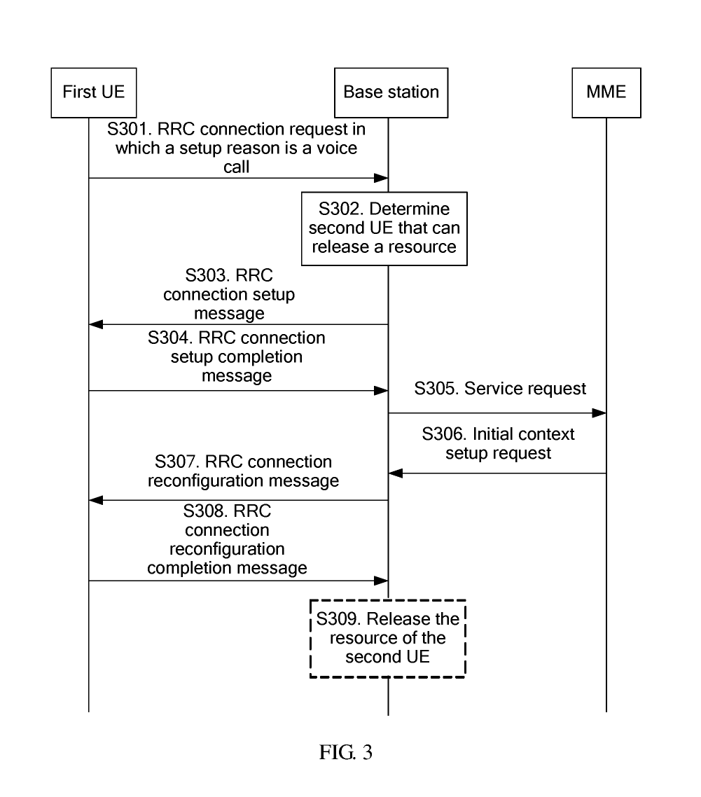

FIG. 3 is a flowchart of a method for providing network access to UE requesting a voice service according to an embodiment of the present invention. As shown in FIG. 3, the method in this embodiment includes:

S301. First UE sends an RRC connection request to a base station, where a setup reason in the RRC connection request is or indicates a voice call.

S302. When the base station is in a congested state, the base station determines second UE that can release a resource.

S303. The base station sends an RRC connection setup message to the first UE.

In this embodiment of the present invention, the base station receives the RRC connection request sent by the first UE, and learns that the setup reason is the voice call. When the base station is in the congested state, the base station sends the RRC connection setup message to the first UE after determining the second UE that can release the resource.

Optionally, according to a setup reason of UE that has accessed, the base station determines, from the UE that has accessed, the second UE that can release the resource. Optionally, the base station determines, from the UE that has accessed, that UE that has accessed and whose setup reason is or indicates a non-voice call is the second UE, and sends the RRC connection setup message to the first UE.

There is no order of sequence between S302 and S303. Preferably, after determining the second UE that can release the resource, the base station sends the RRC connection setup message to the first UE. This embodiment of the present invention imposes no specific limitation on how the base station determines the second UE that can release the resource. The second UE may be randomly determined, or the second UE may be determined according to a rule.

S304. The first UE sends an RRC connection setup completion message to the base station, where the RRC connection setup completion message carries a service request.

S305. The base station sends the service request to an MME.

The base station receives the RRC connection setup completion message sent by the first UE, obtains the service request carried in the RRC connection setup completion message, and sends the service request to the MME.

S306. The MME sends an initial context setup request to the base station.

S307. The base station sends an RRC connection reconfiguration message to the first UE.

S308. The first UE sends an RRC connection reconfiguration completion message to the base station.

The first UE receives the RRC connection reconfiguration message sent by the base station, and performs corresponding configuration. After completing the corresponding configuration, the UE sends the RRC connection reconfiguration completion message to the base station, so that the base station further exchanges information with the MME and the first UE completes voice service access.

S309. The base station releases the resource of the second UE.

An operation of the base station to release the resource of the second UE in S309 may be performed at any moment after S302, that is, an execution order of S309 is not limited to that in this embodiment. The base station may immediately release the resource of the second UE after determining the second UE, so that the base station in a normal operating status allows the first UE to access a network; or in an overloaded operating status, the base station may first allow the first UE to access the network, then release the resource of the determined second UE, and finally ensure that the base station operates in a normal status.

Preferably, the base station releases the second UE after receiving the RRC connection reconfiguration completion message sent by the first UE.

Although the base station may operate when overloaded within a range, ensuring that the base station operates within a normal range and further allowing the UE providing a voice service to access the network better help to ensure user experience of the UE providing a voice service. The base station determines the second UE of a non-voice service according to a setup reason, and releases the resource of the second UE, so that the UE providing a voice service can access the network when the base station is congested, thereby further ensuring user experience of the first UE providing a voice service.

According to this embodiment of the present invention, by adding a setup reason of a voice call to an RRC connection request that is sent to a base station by UE, when in a congested state, the base station still allows UE that performs a voice service to access a network, which ensures that the base station operates within a normal range and further allows the UE providing a voice service to access the network, thereby improving user experience of the UE providing a voice service.

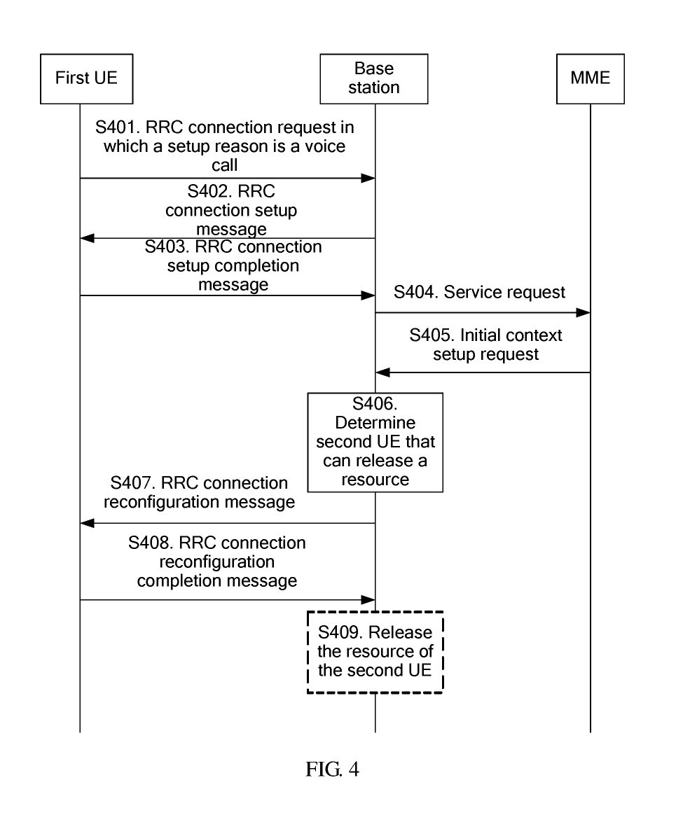

FIG. 4 is a flowchart of a method for providing network access to UE requesting a voice service according to an embodiment of the present invention. As shown in FIG. 4, the method in this embodiment includes:

S401. First UE sends an RRC connection request to a base station, where a setup reason in the RRC connection request is a voice call.

S402. The base station sends an RRC connection setup message to the first UE when the base station is in a congested state.

S403. The first UE sends an RRC connection setup completion message to the base station, where the RRC connection setup completion message carries a service request.

S404. The base station sends the service request to an MME.

S405. The MME sends an initial context setup request to the base station.

S406. The base station determines second UE that can release a resource.

After receiving the initial context setup request sent by the MME, the base station determines the second UE that can release the resource. By using obtained information, the base station may determine, from different dimensions, the second UE that can release the resource.

Optionally, according to a user priority, a service priority, or a setup reason, the base station may determine, from UE that has accessed, the second UE that can release the resource.

The initial context setup request includes a user priority or a service priority of the first UE. The base station may learn a user priority or a service priority of the UE that has accessed. The base station determines, according to the user priority or the service priority, the second UE that can release the resource. Specifically, the base station selects UE that has accessed and whose user priority or service priority is relatively low as the second UE.

Optionally, according to a user priority and a setup reason, or a service priority and a setup reason of the UE that has accessed, the base station may determine, from the UE that has accessed, the second UE that can release the resource. Because user priorities or service priorities of several UEs in the UEs that has accessed the base station may be the same, if the second UE that can release the resource is determined only according to the user priority or the service priority of the UE, the determined second UE may be UE that is performing a voice service. Therefore, according to a user priority and a setup reason, or a service priority and a setup reason, UE that has accessed of a non-voice call may be selected as the second UE when there are at least two UEs whose user priorities or service priorities are the lowest in the UEs that have accessed.

Optionally, the user priority or the service priority is an allocation and retention priority (ARP).

Optionally, the base station may select, from the UE that has accessed, the second UE whose setup reason is or indicates a non-voice call.

Optionally, the base station may randomly select the second UE from the UE that has accessed. This embodiment of the present invention imposes no specific limitation on how to select the second UE.

S407. The base station sends an RRC connection reconfiguration message to the first UE.

After determining the second UE that can release the resource, the base station sends the RRC connection reconfiguration message to the first UE.

S408. The first UE sends an RRC connection reconfiguration completion message to the base station.

S409. The base station releases the resource of the second UE.

Optionally, the base station can release the resource of the second UE at any stage after determining the second UE that can release the resource.

Specific implementation methods of S407 to S409 are the same as the implementation methods of S307 to S309 in FIG. 3, and details are as described above.

According to a user priority or a service priority, or further considering a setup reason on this basis, the base station determines the second UE, and releases the resource of the second UE, thereby further ensuring user experience of the first UE providing a voice service.

According to this embodiment of the present invention, by adding a setup reason of a voice call to an RRC connection request that is sent to a base station by UE, when in a congested state, the base station still allows UE that performs a voice service to access a network, which ensures that the base station operates within a normal range and further allows the UE providing a voice service to access the network, thereby improving user experience of the UE providing a voice service.

Further, in the embodiments shown in FIG. 2 to FIG. 4, whether the base station is in the congested state may be determined by judgment: when a number of UEs that have accessed reaches a maximum capability value of the base station, the base station determines that the base station is in the congested state; or when a number of UEs that have accessed reaches an access license quantity value of the base station, the base station determines that the base station is in the congested state.

In the embodiments shown in FIG. 2 to FIG. 4, by adding the setup reason of a voice call, the RRC connection request that is sent to the base station by the UE that performs the voice call carries the setup reason of a voice call. Therefore, when in the congested state, the base station sends an RRC connection setup message to the UE according to (or based on) the setup reason being a voice call, so that the UE further completes voice service access.

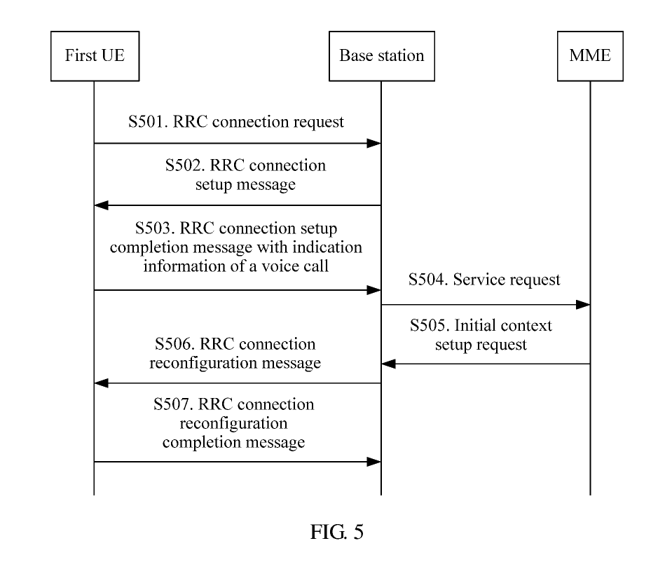

Optionally, as shown in FIG. 5, an embodiment of the present invention provides another possible implementation method. FIG. 5 is a flowchart of a method for providing network access to UE requesting a voice service according to an embodiment of the present invention. The method in this embodiment includes:

S501. First UE sends an RRC connection request to a base station.

When initiating a voice service, the first UE in an idle state sends an RRC connection request to the base station. The UE may be calling UE, or may be called UE.

S502. The base station sends an RRC connection setup message to the first UE when the base station is in a congested state.

When the base station is in the congested state, regardless of what service that is initiated by the first UE, the base station sends the RRC connection setup message to the first UE.

S503. The first UE sends an RRC connection setup completion message to the base station, where the RRC connection setup completion message carries a service request, and the service request carries indication information of a voice call.

After receiving the RRC connection setup message, the first UE sends the RRC connection setup completion message to the base station, where the RRC connection setup completion message carries the service request, and the service request is a NAS message. The service request includes the indication information of a voice call.

S504. The base station sends the service request to an MME.

The base station obtains the service request after receiving the RRC connection setup completion message sent by the UE. Because the service request is the NAS message, the base station sends the service request to the MME. Optionally, the base station sends an initial UE message carrying the service request to the MME.

S505. The MME sends an initial context setup request to the base station.

After receiving the service request, the MME allocates related access information to the first UE, configures initial context information for the first UE, and then sends the initial context setup request to the base station.

S506. The base station sends an RRC connection reconfiguration message to the first UE.

After receiving the initial context setup request sent by the MME, the base station sends the RRC connection reconfiguration message to the first UE.

S507. The first UE sends an RRC connection reconfiguration completion message to the base station.

Different from the foregoing embodiments in which a setup reason of a voice call is extended in an RRC connection request, according to this embodiment of the present invention, indication information of a voice call is carried in a service request, so that UE initiating a voice call can still normally access a network when a base station is congested.

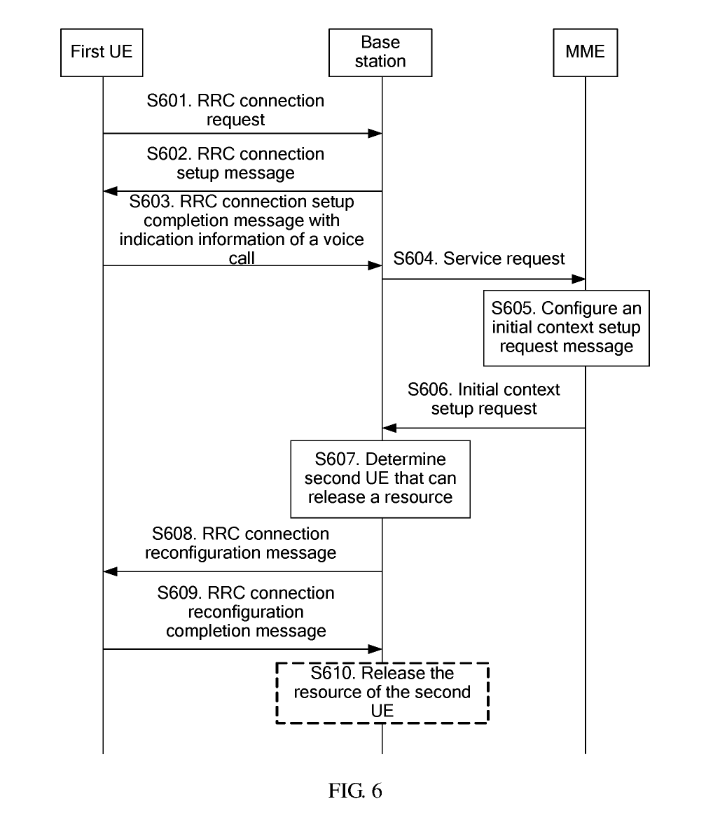

FIG. 6 is a flowchart of a method for providing network access to UE requesting a voice service according to an embodiment of the present invention. As shown in FIG. 6, the method in this embodiment includes:

S601. First UE sends an RRC connection request to a base station.

In this embodiment of the present invention, the prior art in which a setup reason of a voice call is not added to an RRC connection request is used.

S602. The base station sends an RRC connection setup message to the first UE when the base station is in a congested state.

After the base station receives the RRC connection request sent by the first UE, regardless of what type of service that is initiated by the first UE, when the base station is in the congested state, the base station sends the RRC connection setup message to the first UE, so that the first UE continues to perform a subsequent access procedure.

S603. The first UE sends an RRC connection setup completion message to the base station, where the RRC connection setup completion message carries a service request, and the service request carries indication information of a voice call.

After receiving the RRC connection setup message sent by the base station, the first UE sends the RRC connection setup completion message to the base station, where the RRC connection setup completion message carries the service request, and the service request carries the indication information of a voice call.

S604. The base station sends the service request to an MME.

After receiving the RRC connection setup completion message, the base station sends the carried service request to the MME.

S605. The MME configures an initial context setup request for the first UE, where a user priority or a service priority in the initial context setup request is a high priority.

Because the service request carries the indication information of a voice call, after receiving the service request, the MME learns that the first UE is UE of a voice call.

In a process of accessing a network by the UE, the MME configures a different user priority or service priority for the UE in the initial context setup request. A low user priority or service priority of the UE means that the UE is unimportant UE or that the UE is performing an unimportant service. When the service request received by the MME includes the indication information of a voice call, the user priority or the service priority of the first UE is configured as a high priority.

The foregoing user priority or service priority includes an allocation and retention priority (ARP).

S606. The MME sends the initial context setup request to the base station.

S607. The base station determines second UE that can release a resource.

The base station may learn a user priority or a service priority of each UE that has accessed, and therefore, the base station obtains the user priority or the service priority of the first UE after the base station receives an initial context setup request sent by the MME. The base station determines, according to the user priority or the service priority of the first UE, and the user priority or the service priority of the UE that has accessed, UE that has accessed as the second UE that can release the resource.

Optionally, the base station determines UE that has accessed and whose user priority or service priority is the lowest as the second UE. Optionally, the base station may randomly determine UE that has accessed as the second UE.

S608. The base station sends an RRC connection reconfiguration message to the first UE.

After determining the second UE that can release the resource, the base station sends the RRC connection reconfiguration message to the first UE.

S609. The first UE sends an RRC connection reconfiguration completion message to the base station.

S610. The base station releases the resource of the second UE.

Optionally, the base station can release the resource of the second UE at any stage after determining the second UE that can release the resource.

Specific implementation methods of S608 to S610 are the same as the implementation methods of S307 to S309 in FIG. 3, and details are as described above.

According to this embodiment, by adding indication information of a voice call to a service request, an MME allocates a user priority or a service priority of a high priority to UE providing a voice service, so that the UE providing a voice service can still access a network when a base station is in a congested state, which ensures that the base station operates within a normal range and further allows the UE providing a voice service to access the network, thereby improving user experience of the UE providing a voice service.

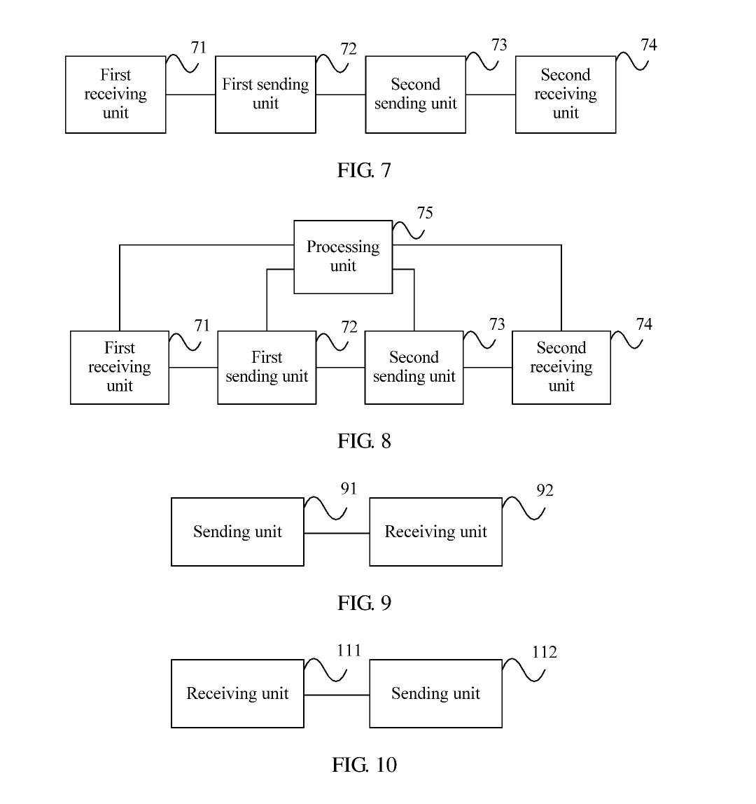

FIG. 7 is a schematic structural diagram of a base station according to an embodiment of the present invention. As shown in FIG. 7, the base station is configured to perform the method according to the embodiment shown in FIG. 2, including:

a first receiving unit 71, configured to receive an RRC connection request sent by first UE, where a setup reason in the RRC connection request is a voice call;

a first sending unit 72, configured to send an RRC connection setup message to the first UE when the base station is in a congested state; where

the first receiving unit 71 is further configured to receive an RRC connection setup completion message sent by the first UE, where the RRC connection setup completion message carries a service request;

a second sending unit 73, configured to send the service request to an MME; and

a second receiving unit 74, configured to receive an initial context setup request sent by the MME; where

the first sending unit 72 is further configured to send an RRC connection reconfiguration message to the first UE; and

the first receiving unit 71 is further configured to receive an RRC connection reconfiguration completion message sent by the first UE, so that the first UE completes voice service access.

A base station obtains an RRC connection request that is sent by first UE and that includes a setup reason of a voice call, when in a congested state, sends an RRC connection setup message to the first UE, and allows the first UE that performs a voice service to access a network, thereby improving user experience of the first UE providing a voice service.

FIG. 8 is a schematic structural diagram of a base station according to an embodiment of the present invention. As shown in FIG. 8, the base station in this embodiment further includes a processing unit 75 on a basis of FIG. 7. The base station is configured to perform the method in the embodiment shown in FIG. 3. The processing unit 75 is configured to: after the first receiving unit 71 receives an RRC connection request sent by first UE and when the base station is in a congested state, determine second UE that can release a resource.

The processing unit 75 is specifically configured to: when the base station is in the congested state, determine, from UE that has accessed according to a setup reason of the UE that has accessed, the second UE that can release the resource. Optionally, the processing unit 75 determines, from the UE that has accessed, UE that has accessed of a non-voice call as the second UE.

After the processing unit 75 determines the second UE that can release the resource, the first sending unit 72 sends an RRC connection setup message to the first UE. Optionally, there is no strict order of sequence between determining, by the processing unit 75, the second UE that can release the resource and sending, by the first sending unit 72, the RRC connection setup message to the first UE.

The processing unit 75 is further configured to release the second UE, and optionally, the processing unit 75 may be configured to release the second UE at any stage after determining the second UE that can release the resource.

Preferably, the first sending unit 72 sends an RRC connection reconfiguration message to the first UE, and the processing unit 75 releases the second UE after the first receiving unit 71 receives an RRC connection reconfiguration completion message sent by the first UE.

The base station determines second UE of a non-voice service according to a setup reason, and releases a resource of the second UE, so that first UE providing a voice service can access a network when the base station is congested, thereby further ensuring user experience of the first UE providing a voice service.

When the base station shown in FIG. 8 performs the method in the embodiment shown in FIG. 4, optionally, the processing unit 75 is configured to: after the second receiving unit 74 receives an initial context setup request sent by an MME, determine second UE that can release a resource.

The processing unit 75 is specifically configured to determine, from UE that has accessed according to a user priority or a service priority, the second UE that can release the resource. Optionally, UE that has accessed and whose user priority or service priority is relatively low is selected as the second UE.

Optionally, the processing unit 75 is specifically configured to determine, from the UE that has accessed according to a user priority and a setup reason, or a service priority and a setup reason of the UE that has accessed, the second UE that can release the resource.

Optionally, the processing unit 75 is specifically configured to determine second UE of a non-voice service from the UE that has accessed according to a setup reason of the UE that has accessed, or randomly determine UE that has accessed as the second UE.

Optionally, the user priority or the service priority is an ARP.

After the processing unit 75 determines the second UE that can release the resource, the first sending unit 72 sends an RRC connection reconfiguration message to first UE.

The processing unit 75 is further configured to release the second UE after the first sending unit 72 sends the RRC connection reconfiguration message to the first UE, and optionally, the processing unit 75 may be configured to release the second UE at any stage after determining the second UE that can release the resource.

Preferably, the first sending unit 72 sends the RRC connection reconfiguration message to the first UE, and the processing unit 75 releases the second UE after the first receiving unit 71 receives an RRC connection reconfiguration completion message sent by the first UE.

According to a user priority or a service priority, or further considering a setup reason on this basis, the base station determines the second UE, and releases the resource of the second UE, thereby further ensuring user experience of the first UE providing a voice service.

Optionally, to perform the method in the embodiment shown in FIG. 5, the first receiving unit 71 is configured to receive a Radio Resource Control (RRC) connection request sent by first UE.

The first sending unit 72 is configured to send an RRC connection setup message to the first UE when the base station is in a congested state.

The first receiving unit 71 is further configured to receive an RRC connection setup completion message sent by the first UE, where the RRC connection setup completion message carries a service request, and the service request carries indication information of a voice call.

The second sending unit 73 is further configured to send the service request to a mobility management entity (MME).

The second receiving unit 74 is further configured to receive an initial context setup request sent by the MME.

The first sending unit 72 is further configured to send an RRC connection reconfiguration message to the first UE, so that the first UE completes voice service access.

Optionally, to perform the method in the embodiment shown in FIG. 6, the processing unit 75 is configured to: after the second receiving unit 74 receives the initial context setup request sent by the MME, determine second UE that can release a resource, and release the resource of the second UE.

Optionally, the processing unit 75 is specifically configured to determine, according to a user priority or a service priority, the second UE that can release the resource. After learning that the first UE is UE of a voice call, the MME may configure a relatively high user priority or service priority for the first UE.

Optionally, the user priority or the service priority includes an ARP.

Indication information of a voice call is carried in a service request of first UE, so that the base station obtains a user priority or a service priority that an MME configures for the first UE. Then, the base station may determine, according to the user priority or the service priority of the first UE, and a user priority or a service priority of UE that has accessed, second UE that can release a resource, which ensures that the first UE providing a voice service can access a network when the base station is in a congested state, thereby improving user experience of the first UE providing a voice service.

Further, the processing unit 75 is further configured to: when a number of UEs that have accessed reaches a maximum capability value of the base station, determine that the base station is in the congested state; or when a number of UEs that have accessed reaches an access license quantity value of the base station, determine that the base station is in the congested state.

It should be noted that the processing unit 75 in this embodiment of the present invention may be a processor of the base station, or may be implemented by being integrated into a processor of the base station; in addition, the processing unit 75 may also be stored in a memory of the base station in a form of program code, and the foregoing functions of the processing unit 75 are invoked and executed by a processor of the base station. The first sending unit 72 and the first receiving unit 71 may be respectively corresponding to a transmitter and a receiver of the base station, or may be corresponding to a transceiver of the base station. The second sending unit 73 and the second receiving unit 74 may be respectively corresponding to a sending interface and a receiving interface of the base station. The processor described herein may be a central processing unit (CPU), or an application-specific integrated circuit (ASIC), or one or more integrated circuits for completing implementation of this embodiment of the present invention.

FIG. 9 is a schematic structural diagram of UE according to an embodiment of the present invention. As shown in FIG. 9, the UE is configured to perform the methods in the embodiments shown in FIG. 2 to FIG. 4, including:

a sending unit 91, configured to send an RRC connection request to a base station, where a setup reason in the RRC connection request is a voice call; and

a receiving unit 92, configured to receive an RRC connection setup message sent by the base station, where the RRC connection setup message is sent by the base station to the user equipment (UE) based on the setup reason of a voice call when the base station is in a congested state; where

the sending unit 91 is further configured to send an RRC connection setup completion message to the base station, where the RRC connection setup completion message carries a service request, so that the base station sends the service request to an MME;

the receiving unit 92 is further configured to receive an RRC connection reconfiguration message sent by the base station, and the RRC connection reconfiguration message is sent to the UE after the base station receives an initial context setup request sent by the MME; and

the sending unit 91 is further configured to send an RRC connection reconfiguration completion message to the base station, so as to complete voice service access.

By sending an RRC connection request that includes a setup reason of a voice call to a base station, the UE enables the base station to send an RRC connection setup message to the UE when the base station is in a congested state, and to allow the UE that performs a voice service to access a network, thereby improving user experience of the UE providing a voice service when the base station is in the congested state.

To perform the methods in the embodiments shown in FIG. 5 and FIG. 6, optionally, the sending unit 91 is configured to send an RRC connection request to a base station.

The receiving unit 92 is configured to receive an RRC connection setup message sent by the base station, where the RRC connection setup message is sent by the base station to the UE when the base station is in a congested state.

The sending unit 91 is further configured to send an RRC connection setup completion message to the base station, where the RRC connection setup completion message carries a service request, and the service request carries indication information of a voice call, so that the base station sends the service request to an MME, and the base station sends an RRC connection reconfiguration message to the UE after the base station receives an initial context setup request sent by the MME.

The receiving unit 92 is further configured to receive the RRC connection reconfiguration message sent by the base station, where the RRC connection reconfiguration message is sent to the UE after the base station receives the initial context setup request sent by the MME.

The sending unit 91 is further configured to send an RRC connection reconfiguration completion message to the base station, so as to complete voice service access.

By sending a service request that includes indication information of a voice call to a base station, the UE enables the base station to allow, when the base station is in a congested state, the UE that performs a voice service to access a network, thereby improving user experience of the UE providing a voice service when the base station is in the congested state.

It should be noted that the sending unit 91 and the receiving unit 92 in this embodiment of the present invention may be respectively corresponding to a transmitter and a receiver of the UE, or may be corresponding to a transceiver of the UE. Optionally, the UE further includes a processor, a memory, and the like. The memory is configured to store instruction code. The processor is configured to invoke the instruction code in the memory, to control the sending unit 91 and the receiving unit 92 in this embodiment of the present invention to perform the foregoing operations. The processor described herein may be a central processing unit (CPU), or an application-specific integrated circuit (ASIC), or one or more integrated circuits for completing implementation of this embodiment of the present invention.

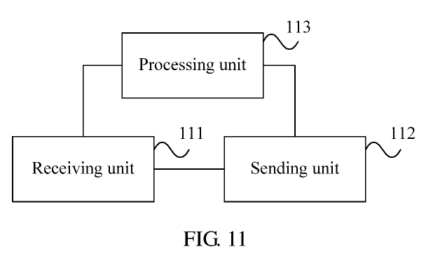

FIG. 10 is a schematic structural diagram of an MME according to an embodiment of the present invention. As shown in FIG. 10, the MME is configured to perform the method in the embodiment shown in FIG. 5, including:

a receiving unit 111, configured to receive a service request sent by a base station, where the service request carries indication information of a voice call, the service request is sent to the MME after the base station receives an RRC connection request sent by first UE and when the base station is in a congested state, and the RRC connection request carries the service request; and

a sending unit 112, configured to send an initial context setup request to the base station, so that the base station sends an RRC connection reconfiguration message to the first UE and the first UE completes voice service access.

To perform the method in the embodiment shown in FIG. 6, optionally, the MME further includes: a processing unit 113, as shown in FIG. 11. FIG. 11 is a schematic structural diagram of an MME according to an embodiment of the present invention. The processing unit 113 is configured to configure the initial context setup request for the first UE according to the indication information of a voice call received by the receiving unit 111, where a user priority or a service priority in the initial context setup request is a high priority, to ensure user experience of UE providing a voice service.

Optionally, the user priority or the service priority includes an ARP.

By obtaining a service request that carries indication information of a voice call and is sent by first UE, the MME configures a relatively high user priority or service priority for the first UE providing a voice service, so that the base station determines, according to the user priority or the service priority, second UE that can release a resource, which ensures that the first UE providing a voice service can access a network when the base station is in a congested state, thereby improving user experience of the first UE providing a voice service.

It should be noted that the processing unit 113 in this embodiment of the present invention may be a processor of the MME, or may be implemented by being integrated into a processor of the MME; in addition, the processing unit 113 may also be stored in a memory of the MME in a form of program code, and the foregoing functions of the processing unit 113 are invoked and executed by a processor of the MME. The sending unit 112 and the receiving unit 111 may be respectively corresponding to a sending interface and a receiving interface of the MME. The processor described herein may be a central processing unit (CPU), or an application-specific integrated circuit (ASIC), or one or more integrated circuits for completing implementation of this embodiment of the present invention.

Persons of ordinary skill in the art may understand that all or some of the steps of the method embodiments may be implemented by a program instructing relevant hardware. The program may be stored in a computer-readable storage medium. When the program runs, the steps of the method embodiments are performed. The foregoing storage medium includes: any medium that can store program code, such as a ROM, a RAM, a magnetic disk, or an optical disc.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof. Therefore, the protection scope of the present invention shall be subject to the protection scope of the claims.

What is claimed is:

1. A method for providing network access comprising:
receiving, by a base station, a radio resource control (RRC) connection request message sent by a first mobile device, wherein a setup reason in the RRC connection request message indicates a voice call;
identifying, by the base station, that the first mobile device initiates a voice service according to the setup reason in the RRC connection request message; and
sending, by the base station, an RRC connection setup message to the first mobile device.

2. The method according to claim 1, further comprising:
receiving, by the base station, an RRC connection setup completion message sent by the first mobile device, wherein the RRC connection setup completion message carries a service request;
sending, by the base station, the service request to a mobility management entity (MME);
receiving, by the base station, an initial context setup request message sent by the MME;
sending, by the base station, an RRC connection reconfiguration message to the first mobile device; and
receiving, by the base station, an RRC connection reconfiguration completion message sent by the first mobile device.

3. The method according to claim 1, wherein the voice call comprises: a voice call in long term evolution (LTE) system or a voice call of circuit switched fallback (CSFB).

4. The method according to claim 1, further comprising:
determining, by the base station, a second mobile device which can be released; and
releasing, by the base station, a resource of the second mobile device.

5. The method according to claim 4, wherein the determining, by the base station, a second mobile device which can be released comprises:
determining, by the base station, the second mobile device which can be released based on a setup reason of the second mobile device being a non-voice call.

6. The method according to claim 1, further comprising:
determining, by the base station, the base station is in a congested state.

7. The method according to claim 6, wherein determining, by the base station, the base station is in a congested state comprises:
when a number of mobile devices that have accessed reaches a maximum capability value of the base station, determining, by the base station, that the base station is in the congested state.

8. The method according to claim 6, wherein determining, by the base station, the base station is in a congested state comprises:
when a number of mobile devices that have accessed reaches an access license quantity value of the base station, determining, by the base station, that the base station is in the congested state.

9. The method according to claim 1, wherein the base station is an evolved NodeB (eNB).

10. A base station for providing network access comprising:
a transceiver, configured to receive a radio resource control (RRC) connection request sent by first mobile device, wherein a setup reason in the RRC connection request indicates a voice call;
a processor, configured to identify that the first mobile device initiates a voice service according to the setup reason in the RRC connection request message; and
the transceiver, further configured to send an RRC connection setup message to the first mobile device.

11. The base station according to claim 10, wherein
the transceiver is further configured to receive an RRC connection setup completion message sent by the first mobile device, wherein the RRC connection setup completion message carries a service request;
a sending interface, configured to send the service request to a mobility management entity (MME);
a receiving interface, configured to receive an initial context setup request message sent by the MME; and
the transceiver is further configured to send an RRC connection reconfiguration message to the first mobile device, and receive an RRC connection reconfiguration completion message sent by the first mobile device.

12. The base station according to claim 10, wherein the voice call comprises: voice call in long term evolution (LTE) system or a voice call of circuit switched fallback (CSFB).

13. The base station according to claim 10, wherein the processor further configured to:
determine a second mobile device which can be released; and release a resource of the second mobile device.

14. The base station according to claim 13, wherein the processor configured to:
determine the second mobile device which can be released based on a setup reason of the second mobile device being a non-voice call.

15. The base station according to claim 10, wherein the processor configured to:
determine the base station is in a congested state.

16. The base station according to claim 15, wherein the processor configured to:
when a number of mobile devices that have accessed reaches a maximum capability value of the base station, determine that the base station is in the congested state.

17. The base station according to claim 15, wherein the processor configured to:
when a number of mobile devices that have accessed reaches an access license quantity value of the base station, determine that the base station is in the congested state.

18. The base station according to claim 10, wherein the base station is an evolved NodeB (eNB).
